(19) United States
(12) Patent Application Publication
(10) Pub. No.: US 2011/0122809 A1
(43) Pub. Date: May 26, 2011

(54) METHOD AND APPARATUS FOR INTERWORKING OF 3GPP LTE AND 3GPP2 LEGACY WIRELESS COMMUNICATION SYSTEMS

(75) Inventors: Ji-Hoon YUN, Seoul (KR); Ki-Ho CHO, Songnam-si (KR); Ji-Cheol MOON, Suwon-si (KR)

(73) Assignee: SAMSUNG ELECTRONICS CO. LTD., Suwon-si (KR)

(21) Appl. No.: 12/623,262

(22) Filed: Nov. 20, 2009

(51) Int. Cl. H04W 4/00

(52) U.S. Cl. 370/328

(57) ABSTRACT

A terminal and an advanced Base Station (BS), and methods for their operation in a wireless communication system including an advanced network that provides a data service and a legacy network that provides a Circuit Switched (CS) voice service, are provided. The method for operating the terminal includes monitoring a paging channel of the advanced network for a data paging message and a paging channel of the legacy network for a CS paging message, when the terminal is in an idle state, receiving one of the CS paging message and data paging message, and establishing a connection with the one of the advanced network and the legacy network corresponding to the received one of the CS paging message and data paging message.

### BACKGROUND OF THE INVENTION

1. Field of the Invention

The present invention relates to a wireless communication system. More particularly, the present invention relates to an apparatus and method for interworking between a 3^{rd} Generation Partnership Project (3GPP) Long Term Evolution (LTE) and 3GPP2 legacy wireless communication systems.

2. Description of the Related Art

Research is being conducted to develop a next generation communication system. A representative example of the next generation communication system is a communication system based on the 3^{rd} Generation Partnership Project (3GPP) Long Term Evolution (LTE) standard (hereafter referred to as an LTE network). When the LTE network is deployed, it is expected that the LTE network will coexist with a legacy communication system in an overlay mode. A representative example of the legacy communication system is a communication system based on a 3^{rd} Generation Partnership Project 2 (3GPP2) CDMA2000 1x Radio Transmission Technology (RTT) standard (hereafter referred to as a 1x network).

When an operator newly deploys the LTE network in the overlay mode, the operator may support a voice service through the 1x network and may support a data service through the LTE network. When the voice service is supported through the 1x network, the voice service may be referred to as a Circuit Switched (CS) voice service. When the LTE network is deployed in the overlay mode, a terminal for use therein should be a dual mode terminal that supports a Radio Access Technology (RAT) of both the 1x network and the LTE network. In addition, the terminal should be capable of receiving paging messages of the 1x network and the LTE network.

To support the CS voice service through the 1x network and to support the data service through the LTE network, a conventional function referred to as CS fallback may be employed. An example of the conventional CS fallback will be described below with reference to FIG. 1.

FIG. 1 illustrates a system configuration for conventional CS fallback between the LTE network and a 1x network.

Referring to FIG. 1, a system configuration for CS fallback between the LTE network and the 1x network includes a terminal 100, a 1x Access Node (AN) 110, a 1x Mobile Switching Center (MSC) 112, an Evolved-Universal Mobile Telecommunications System (UMTS) Terrestrial Radio Access Network (E-UTRAN) 120, a Mobility Management Entity (MME) 122, a Serving/Public Data Network-GateWay (S/P-GW) 124 and a 1x InterWorking Solution (1x IWS) 130. The terminal 100 is common to both the LTE network and the 1x network. The 1x AN 110 and a 1x MSC 112 are included in the 1x network. The E-UTRAN 120, MME 122 and S/P-GW 124 are included in the LTE network. The LTE network and 1x network are connected with each other by the 1x IWS 130. The 1x IWS 130 may be a separate Network Element (NE) or may be included with the MME 122 or 1x MSC 112 as a software block as a logical node.

In the 1x network, the 1x AN 110 communicates with the 1x MSC 112 via an A1 interface. In the LTE network, the terminal 100 communicates with the E-UTRAN 110 via an LTE-Uu interface. The E-UTRAN 110 communicates with the MME 122 via an S1-MME interface and the S/P-GW 124 via an S1-U interface. The S/P-GW 124 and the MME 122 communicate with each other via an S11 interface. The MME 122 communicates with the 1x IWS 130 via an S102 interface and the 1x MSC 112 communicates with the 1x IWS 130 via an A1 interface.

When the 1x MSC 112 receives a call request for the CS voice service, the 1x MSC 112 sends a CS paging message to the terminal 100 through a 1x cell in which the terminal 100 is located. However, when the terminal 100 is located in an LTE cell, the 1x MSC 112 sends a CS paging message to the terminal 100 through the LTE cell via the 1x IWS 130.

The terminal 100 registers with the 1x MSC 112 to inform the 1x MSC 112 of its location so that the 1x MSC 112 is aware of the location of the terminal 100. When the terminal 100 is within a service coverage area of the LTE network, the LTE network performs tunneling for the CS paging message between the terminal 100 and the 1x MSC 112 and for control messages used for a registration area update procedure. When the terminal 100 receives the CS paging message through the LTE network, the terminal 100 releases its connection with the LTE network and connects to the 1x network. The terminal 100 sends a CS paging response message through the 1x network, after which, the 1x CS voice service is initiated. Therefore, as described above, the CS fallback allows the terminal to receive a CS paging message from the 1x network, even when the terminal is connected to the LTE network.

However, when the operator newly deploys the LTE network in the overlay mode, it is expected that the coverage area and signal quality of the early LTE network will be limited compared to the 1x network. That is, there will be areas that are serviced by the 1x network that are not serviced by the LTE network. In addition, there will be areas that are serviced by the LTE network in which the terminal poorly receives signals from the LTE network. In this environment, there may be a number of problems that are encountered, such as those listed below, when receiving the CS paging message through LTE network using the conventional CS fallback.

One problem with the conventional CS fallback involves deterioration of a paging receiving ratio. This problem is experienced when a paging message is lost due to a low quality signal received from the LTE network. As a result, there may be a delay before a CS voice service of the 1x network is established or there may be a failure to establish the CS voice service of the 1x network. The CS voice service is one of the basic services of a wireless network, and thus a receiving ratio for the CS voice service is an important element of the quality of service sensed by the user.

Another problem with the conventional CS fallback involves the switching by the terminal from the LTE network to the 1x network for a voice call. The CS voice service is provided by the 1x network after receiving a CS paging message through the LTE network. To achieve this, the terminal has to switch from the LTE network to the 1x network. The switching from the LTE network to the 1x network introduces a delay before the start of the voice service. The delay affects the quality of service sensed by the user.

Yet another problem with the conventional CS fallback is that, due to the inconsistent service coverage area of the LTE network, the terminal frequently switches between the LTE network and the 1x network. In the conventional CS fallback, it is required that the terminal camp on the LTE network when it is available and only camp on the 1x network when the LTE network is not available. In addition, when the terminal is camped on the 1x network, the terminal should continuously search for the LTE network and camp on the LTE network once it is found. However, these operations result in a consumption of the terminal's battery power and a reduction of the efficiency of both the 1x network and the LTE network.

One technique that may be employed to address the shortcomings of the conventional CS fallback is to employ a hybrid operation on the terminal. The hybrid operation denotes that the terminal takes turns monitoring a paging channel in the 1x network and the LTE network. In the hybrid operation, the terminal may maintain a substantially identical receiving ratio because the terminal receives the CS paging messages through an air interface with the 1x network. However, in the hybrid operation, the terminal switches to the 1x network even when the terminal is sending/receiving data through an active connection with the LTE network. Accordingly, performance of the LTE network is compromised.

Therefore, a need exists for an apparatus and method for enhancing a receiving ratio of the CS voice service with greater reliability than the conventional CS fallback, while not decreasing performance of the LTE network.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for interworking between a communication system based on a 3^{rd} Generation Partnership Project (3GPP) Long Term Evolution (LTE) standard (hereafter referred to as an LTE network) and a communication system based on a 3^{rd} Generation Partnership Project 2 (3GPP2) CDMA2000 1x Radio Transmission Technology (RTT) standard (hereafter referred to as a 1x network), which are deployed in an overlay mode.

Another aspect of the present invention is to provide an apparatus and method for enhancing a receiving ratio of a Circuit Switched (CS) voice service with greater reliability than the conventional CS fallback, while not decreasing performance of the LTE network.

In accordance with an aspect of the present invention, a method for operating a terminal in a wireless communication system including an advanced network that provides a data service and a legacy network that provides a CS voice service is provided. The method includes monitoring a paging channel of the advanced network for a data paging message and a paging channel of the legacy network for a CS paging message, when the terminal is in an idle state, receiving one of the CS paging message and data paging message, and establishing a connection with the one of the advanced network and the legacy network corresponding to the received one of the CS paging message and data paging message.

In accordance with another aspect of the present invention, a method for operating a Base Station (BS) of an advanced network in a wireless communication system including the advanced network that provides a data service and a legacy network that provides a CS voice service is provided. The method includes receiving from a Mobility Management Entity (MME) a paging message for a terminal, determining a paging slot in which to transmit the paging message based on a paging offset and in consideration of the legacy network, and transmitting the paging message in the determined paging slot.

In accordance with yet another aspect of the present invention, a terminal for use in a wireless communication system including an advanced network that provides a data service and a legacy network that provides a CS voice service is provided. The terminal includes a transmitter for transmitting signals to the advanced network and the legacy network, a receiver for receiving signals from the advanced network and the legacy network, and a controller for controlling the transmitter and receiver, for controlling to monitor a paging channel of the advanced network for a data paging message and a paging channel of the legacy network for a CS paging message, when the terminal is in an idle state, for controlling to determine if one of the CS paging message and data paging message are received, and if one of the CS paging message and data paging message are received, for controlling to establish a connection with the one of the advanced network and the legacy network corresponding to the received one of the CS paging message and data paging message

In accordance with still another aspect of the present invention, a Base Station (BS) of an advanced network for use in a wireless communication system including the advanced network that provides a data service and a legacy network that provides a CS voice service is provided. The BS includes a first receiver for receiving signals from a Mobility Management Entity (MME), a first transmitter for transmitting signals to the MME, a second receiver for receiving signals from the terminal, a second transmitter for transmitting signals to the terminal, and a controller for controlling the first receiver, first transmitter, second receiver and second transmitter, for controlling to receive a paging message for a terminal from the MME via the first transmitter, for controlling to determine a paging slot in which to transmit the paging message based on a paging offset and in consideration of the legacy network, and for controlling to transmit the paging message in the determined paging slot via the second transmitter.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a system configuration for conventional Circuit Switched (CS) fallback between the Long Term Evolution (LTE) network and a 1x network;

FIG. 2 illustrates a procedure for interworking an LTE network and a 1x network, according to an exemplary embodiment of the present invention;

FIG. 3 illustrates examples of independently determined LTE-1x paging slots according to an exemplary embodiment of the present invention;

FIG. 4 illustrates examples of LTE-1x paging slots assigned using a first paging slot assignment scheme according to an exemplary embodiment of the present invention;

FIG. 5 illustrates an exemplary operation of a second paging slot assignment scheme according to an exemplary embodiment of the present invention;

FIG. 6 illustrates a Base Station (BS) operating procedure for interworking an LTE network and a 1x network according to an exemplary embodiment of the present invention;

FIG. 7 illustrates a structure of a terminal for use in an LTE network and a 1x network deployed in an overlay mode according to an exemplary embodiment of the present invention; and

FIG. 8 illustrates an exemplary structure of a BS for use with an LTE network, when the LTE network is deployed with a 1x network in an overly mode, according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention described below relate to an interworking between a communication system based on a 3^{rd} Generation Partnership Project (3GPP) Long Term Evolution (LTE) standard (hereafter referred to as a LTE network) and a communication system based on a legacy 3^{rd} Generation Partnership Project 2 (3GPP2) standard. While a communication system based on the 3GPP2 Code Division Multiple Access 2000 (CDMA2000) 1x Radio Transmission Technology (RTT) standard (hereafter referred to as a 1x network) will hereafter be used as a representative example of a communication system based on a legacy 3GPP2 standard, the present invention is not limited thereto and is equally applicable to any communication system based on a legacy 3GPP2 standard.

It should be understood that the following description refers to terms utilized in various standards merely for simplicity of explanation. For example, the following description refers to terms utilized in the 3GPP LTE standard and the 3GPP2 1x standard. However, this description should not be interpreted as being limited to the 3GPP LTE and 3GPP2 1x standards. Independent of the mechanism used for interworking, it is preferable to use interworking as described herein and it is advantageous for that ability to conform to a standardized mechanism.

Exemplary embodiments of the present invention are described below under the assumption that an LTE network and a 1x network coexist in an overlay mode and that a terminal (also referred to as User Equipment (UE)) is provided a voice service from the 1x network and is provided a data service from the LTE network. Accordingly, the terminal should be an LTE-1x dual mode terminal. However, despite the terminal being a dual mode terminal, it is assumed that the terminal cannot simultaneously receive an LTE signal and a 1x signal. When the voice service is supported through the 1x network, the voice service may be referred to as a Circuit Switched (CS) voice service.

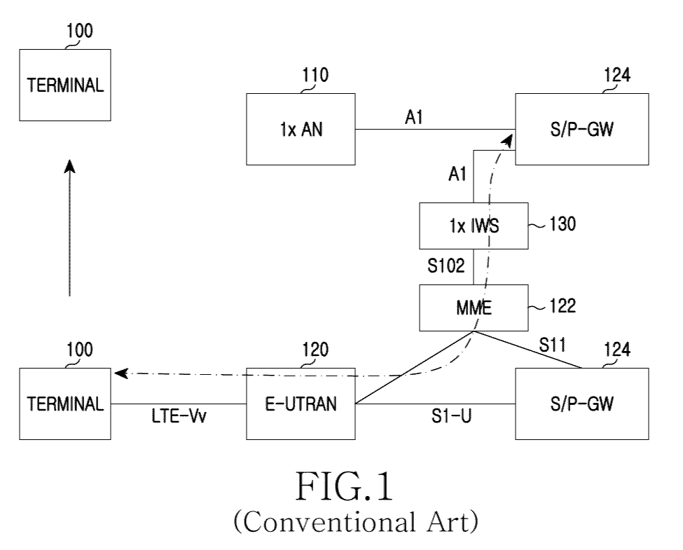

An LTE Base Station (BS) (also referred to as an evolved Node B (eNB)) and 1x BS (also referred to as a 1x Access Node (AN)) may be co-located or may be located separately from each other. The LTE network and 1x network have substantially similar interworking interfaces as those described above with respect to FIG. 1 for the CS fallback system configuration. Thus, the LTE network and the 1x network are interworked by a 1x InterWorking Solution (1x IWS).

Exemplary embodiments of the present invention propose a modification to the conventional CS fallback. The modification to the conventional CS fallback according to exemplary embodiments of the present invention is summarized below in Table 1.

TABLE 1

| terminal status | LTE-1x interworking |
|---|---|
| Idle | CS paging: via 1x network |
| | Data paging: via LTE network |
| LTE active | CS paging: via LTE network |

As shown in Table 1, when the terminal is in an active mode with the LTE network, the conventional CS fallback is implemented. In other words, when the terminal is in an active mode with the LTE network, CS paging is received via the LTE network. However, when the terminal is in an idle mode, CS paging is received via the 1x network and data paging is received via the LTE network. This differs from the conventional CS fallback in that CS paging is directly received via the 1x network instead of being tunneled though and received from the LTE network. Procedures to receive data paging through a data handover between the LTE network and the 1x network and to receive data paging through the 1x network are not yet defined in the corresponding standards. Thus, the terminal, when in an idle mode, should employ a hybrid operation and take turns receiving the paging channel between the LTE network and the 1x network.

The modification to the conventional CS fallback according to exemplary embodiments of the present invention may yield a number of advantages over the conventional CS fallback. For example, since the terminal receives the CS paging through the LTE network in the LTE active mode, the terminal does not have to switch to the 1x network to receive the CS paging message, thereby preventing deterioration of the LTE network's performance.

In addition, the modification to the conventional CS fallback according to exemplary embodiments of the present invention may yield an improvement in a CS paging receiving ratio. Since the terminal receives the CS paging through the LTE network in the LTE active mode and the terminal receives the CS paging through the 1x network in the LTE idle mode, the terminal may maintain a CS paging receiving ratio that is similar to that of the 1x network. This is because the CS paging will occur via the 1x network regardless of whether the terminal is in an LTE service coverage area.

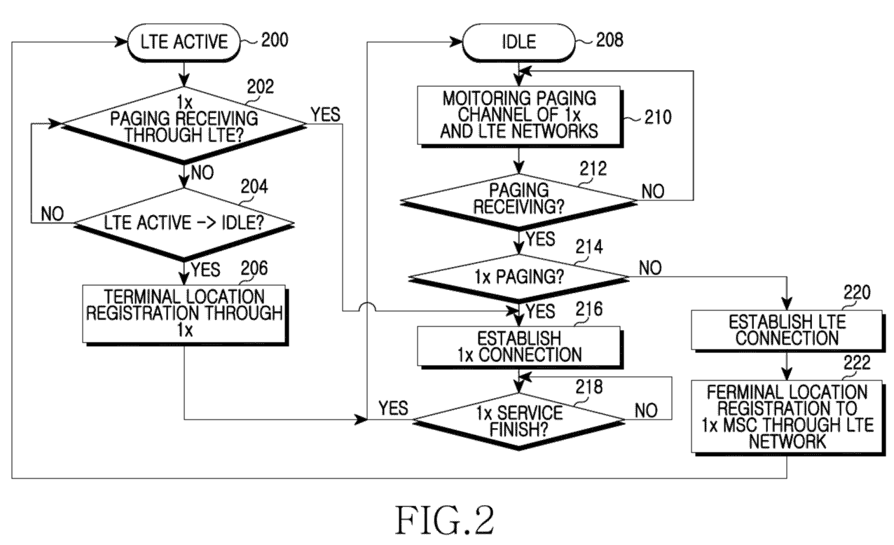

The interworking between the LTE network and the 1x network according to an exemplary embodiment of the present invention will be described in more detail below with reference to FIG. 2.

FIG. 2 illustrates a procedure for interworking an LTE network and a 1x network, according to an exemplary embodiment of the present invention.

Referring to FIG. 2, in step 200 the terminal is in an LTE active state. The LTE active state denotes that a Radio Resource Control (RRC) connection state of the terminal with the LTE network is RRC_CONNECTED and therefore the terminal is in a state in which it is capable of sending data to and receiving data from the LTE network. In step 202, the terminal determines if a CS paging message is received through the LTE network. If the terminal determines that a CS paging message is received through the LTE network at step 202, the terminal proceeds to step 216, which is described below. However, if the terminal determines that a CS paging message is not received through the LTE network at step 202, the terminal determines if the LTE active connection has terminated and transitions to an RRC_IDLE RRC state in step 204. If the terminal determines that the LTE active connection has not terminated at step 204, the terminal returns to step 202. However, if the terminal determines that the LTE active connection has terminated and the terminal is to transition to the idle state, the terminal proceeds to step 206 and performs a location registration procedure with the 1x network after switching to the 1x network. Thereby, the 1x MSC becomes aware of the terminal's location in the 1x network so as to be able to send a CS paging message to the terminal through the 1x network. Thereafter, the terminal proceeds to step 208.

In step 208 the terminal in an LTE idle state. The LTE idle state denotes that that the terminal does not have a connection with the LTE network or 1x network. In step 210, the terminal monitors the paging channels of the LTE network and the 1x network. To monitor the paging channels of the LTE network and the 1x network, the terminal takes turns monitoring the respective paging channels of the LTE network and the 1x network according to paging periods of the LTE and 1x networks. The monitoring of the paging channel of the LTE network and the 1x network according to paging periods of the LTE and 1x networks will be discussed in more detail below. While monitoring of the paging channel of the LTE network and the 1x network, the terminal may perform location registration for the LTE and 1x networks independently. In step 212, the terminal determines if a paging message is received from either the LTE network or the 1x network. If the terminal determines that a paging message from either the LTE network or 1x network is not received at step 212, the terminal returns to step 210. However, if the terminal determines that a paging message is received at step 212, the terminal determines if the received paging message is a CS paging message or a data paging message in step 214. If the terminal determines that the received paging message is a CS paging message, the terminal proceeds to step 216 and establishes a connection with the 1x network. In step 218, the terminal determines if it the 1x service is terminated. When the terminal determines at step 218 that the 1x service is terminated, the terminal returns to step 208.

Returning to step 214, if the terminal determines that the received paging message is a data paging message, the terminal proceeds to step 220 and establishes a connection with the LTE network. In step 222, the terminal performs a location registration with the 1x MSC via a tunneling through the LTE network. Thereby, the terminal receives CS paging messages through the LTE network. After step 222, the terminal returns to step 200.

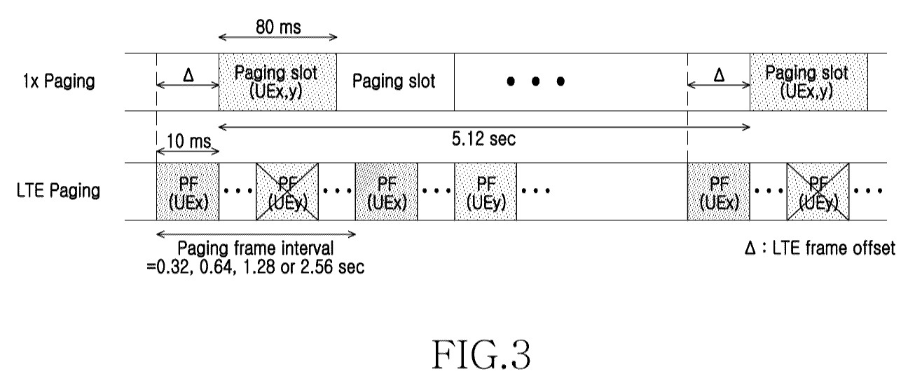

The procedure described above for interworking the LTE network and the 1x network according to an exemplary embodiment of the present invention may encounter a problem when monitoring the paging channel of the LTE network and the 1x network. More specifically, when monitoring the paging channel of the LTE network and the 1x network in step 210, the terminal monitors the paging channels of the LTE network and the 1x network by taking turns monitoring the respective paging channels of the LTE network and the 1x network according to paging periods of the LTE and 1x networks. However, there is a problem in that the paging period for the 1x network and the LTE network are determined independently. Accordingly, the two paging periods may overlap. In this case, because the terminal may receive only one paging channel out of the two paging channels, any paging messages in the other paging channel may be lost. Here, because the paging period of the 1x network and the paging period of the LTE network have a common divisor with each other, when the LTE network is a synchronized network, non-overlapped terminals are not always overlapped and overlapped terminals are always overlapped. Examples of the independently determined paging periods for the 1x network and the LTE network are described below with reference to FIG. 3.

FIG. 3 illustrates examples of independently determined LTE-1x paging slots according to an exemplary embodiment of the present invention.

Referring to FIG. 3, because the paging period is determined independently for the 1x network and the LTE network, UEx and UEy are assigned to an identical paging slot in the 1x network but UEx and UEy are assigned to different paging slots in the LTE network. However, the UEx 1x paging slot and the UEx LTE paging slot do not always overlap. The paging slot of the 1x network and the LTE network maintain a fixed interval of about A. Herein, the paging slot is closest to the UEx in time.

When the paging period of the 1x network is 5.12 sec and the paging period of the LTE network is 2.56 sec, every eleventh LTE paging period or all odd LTE paging periods in the UEy overlap with the 1x paging periods. When 1x paging has a higher priority, the UEy has a 50% probability of receiving the LTE paging during the first LTE paging period.

Two paging slot assignment schemes to address the overlap between the paging periods of the LTE network and the 1x network according to exemplary embodiments of the present invention will be described below. In the first paging slot assignment scheme, a procedure for assigning a paging slot without paging overlap is employed. In the second paging slot assignment scheme, paging overlap detection based on terminal and paging slot offset configuration are employed.

### First Paging Slot Assignment Scheme

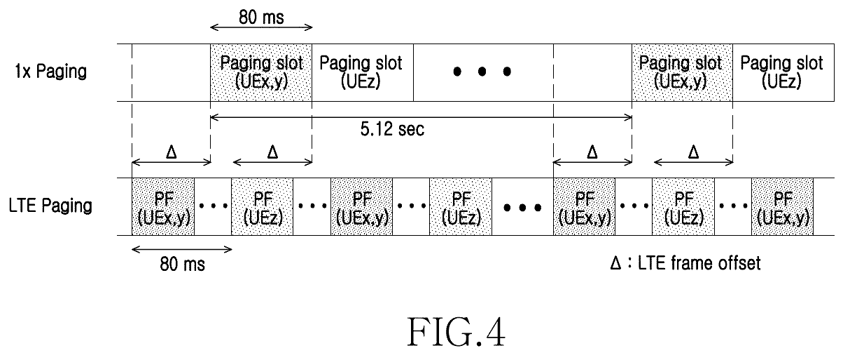

When the LTE network assigns the paging slot for the terminal, an identical time period may be generated, for assigning the paging slot of a specific terminal in the LTE network and 1x network, by employing an identical hash function and a paging slot assignment procedure similar to the 1x network. When a fixed offset is applied, the overlap between the LTE network and the 1x network disappears. Herein, it is assumed that the LTE network and the 1x network use an identical International Mobile Subscriber Identity (IMSI) and that the LTE network and the 1x network are synchronized to each other. An example of an implementation of the first exemplary paging slot assignment scheme is described below with reference to FIG. 4.

FIG. 4 illustrates examples of LTE-1x paging slots assigned using a first paging slot assignment scheme according to an exemplary embodiment of the present invention.

Referring to FIG. 4, the paging slot of the terminal is assigned by the LTE network according to a similar sequence used by the 1x network. This may be accomplished by the LTE network employing a hash function that is identical to the hash function used by the 1x network. In FIG. 4, the interval between Paging Frames (PFs) in the LTE network is set to 80 ms and the LTE frame timing is set by having a difference of Δ, for assigning a slot for the same terminal, between the LTE network and 1x network.

In order to implement the first paging assignment scheme, paging slot assignment rules of the terminal and the eNB may have to be changed to correspond to the first paging assignment scheme, and therefore may depart from a corresponding standard. Thus, an operator that employs the first paging assignment scheme should consider an international roaming terminal. That is, the international roaming terminal monitors paging according to the paging slot determination rule defined in the corresponding standard. Thus, when the terminal is an international roaming terminal, the LTE network should follow the paging slot determination rule defined in the corresponding standard to accommodate the international roaming terminal.

Therefore, to implement the first paging assignment scheme, the eNB that allocates the paging slot of the terminal should determine if the terminal is an international roaming terminal. The eNB can determine if the terminal is an international roaming terminal based on the IMSI of the terminal, which can be determined when a Mobility Management Entity (MME) sends a paging message to the eNB through the S1 interface. The beginning portion of the IMSI comprises a Public Land Mobile Network (PLMN) IDentification (ID) which can be used to identify a geographic origin of the terminal's home network.

However, there may be at least two types of international roaming terminals, such as a LTE+Wideband Code Division Multiple Access (WCDMA) terminal and a LTE+1x terminal. Assuming that the operator is the LTE+1x operator, consideration for each international roaming terminal is shown in Table 2.

TABLE 2

| | Terminal Type | |
|---|---|---|
| | LTE + WCDMA roaming | LTE + 1x roaming |
| | terminal | terminal |
| Voice Service | LTE (Voice over Internet | 1x (CS-fallback) |
| Providing | Protocol (VoIP) is used) | |
| 1X paging | None | Standard |
| receiving | | LTE-1x interworking |
| | | scheme |
| LTE-1x paging | None | None |
| slot overlaps | | |

When the voice service is provided to the LTE+WCDMA roaming terminal, the roaming service should be provided by using the LTE network since the LTE+WCDMA terminal may not be compatible with the 1x network. Thus, it is not required for the LTE+WCDMA terminal to receive the 1x paging and there is no LTE-1x paging overlap. However, the LTE+1x roaming terminal should use the conventional CS fallback for receiving the 1x paging regardless of whether the LTE+1x terminal is in an active state or an idle state in the LTE network. This is because the LTE+1x terminal may not have the appropriate paging slot assignment rules. Accordingly, since conventional CS fallback will be applied to the LTE+1x terminal, there is no overlap problem since only the LTE network is monitored by the terminal.

### Second Paging Assignment Scheme

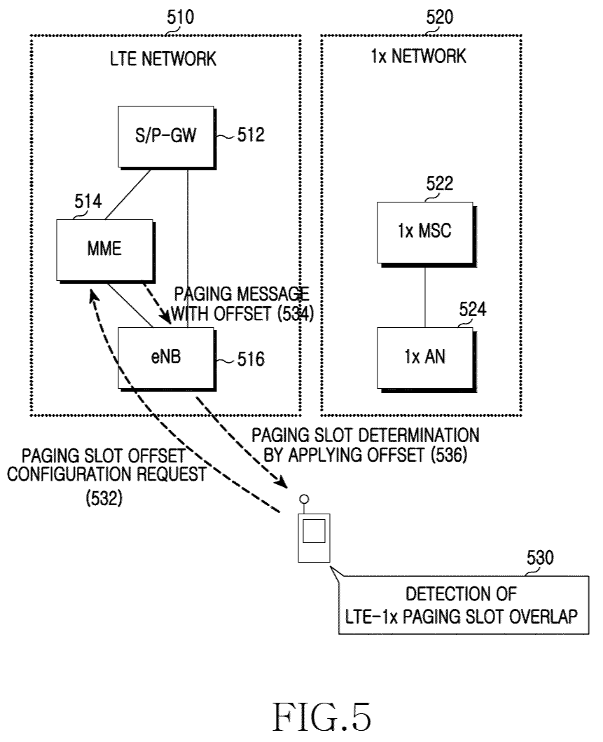

While the first paging assignment scheme addresses the overlap between the paging periods of the LTE network and the 1x network, the LTE network should implement all of the LTE and 1x paging slot assignment rules when employing the first exemplary scheme. However, since the terminals are dual mode terminals, the terminals already posses the paging slot assignment rules of the LTE network and the 1x network. Therefore, the overlap between the paging periods of the LTE network and the 1x network may be addressed at the terminal. The second paging slot assignment scheme according to an exemplary embodiment of the present invention is described below with reference to FIG. 5.

FIG. 5 illustrates an exemplary operation of a second paging slot assignment scheme according to an exemplary embodiment of the present invention.

Referring to FIG. 5, a terminal 500, an LTE network 510, and a 1x network 520 are shown. The LTE network 510 includes a Serving/Public Data Network-GateWay (S/P-GW) 512, MME 514, and eNB 516. The 1x network 520 includes a 1x Mobile Switching Center (MSC) 522 and a 1x Access Node (AN) 524.

The terminal 500, in step 530, determines whether paging overlap will occur between the LTE network and the 1x network. When the terminal determines that paging overlap will occur, the terminal 500, in step 532, requests the MME 514 to set a paging slot offset. The MME 534, in step 534, transmits a paging message together with the paging slot offset of the terminal 500 to the eNB 516. When the eNB 516 performs a paging of the terminal 500 in step 536, the eNB 516 sets the paging slot by applying the paging offset received from the MME 514. When receiving the paging message transmitted from the eNB 516 at step 536, the terminal 500 determines the timing of the paging slot by applying the paging offset.

Configuration of the paging slot offset in the second paging slot assignment scheme may be performed during at least one of two situations, namely when the terminal performs attachment and when the terminal performs a Tracking Area Update (TAU) procedure. Performance of the configuration of the paging slot offset for the two situations will be described below in further detail.

In the first situation, namely when the terminal is performing attachment, an attachment request message is sent to the MME from the terminal in order to perform attachment to the LTE network. The attachment request message may include a Discontinuous Receive (DRX) parameter Information Element (IE) for configuring a terminal specific paging cycle. A terminal specific paging slot offset may be sent with the terminal specific paging cycle configuration at substantially the same time. A DRX parameter IE in which the terminal specific paging slot offset field is added is shown in Table 3.

TABLE 3

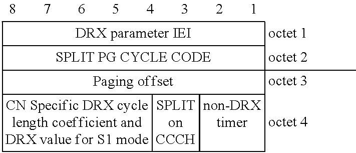

In the second situation, a terminal performs a TAU procedure whenever a tracking area of the LTE network is changed. When the terminal performs the TAU procedure, the terminal transfers a terminal specific paging cycle configuration and a terminal specific paging offset to the MME during the message exchange for the TAU.

The MME saves the paging offset to a terminal context that has been previously stored. The MME adds a paging offset to the paging message which the MME sends to the eNB through a S1-AP interface. An example of the paging offset is shown below in Table 4.

TABLE 4

| IE/Group | | | | Assigned |
|---|---|---|---|---|
| Name | Presence | Range | Criticality | Criticality |
| Message | M | | YES | ignore |
| Type | | | | |
| UE Identity | M | | YES | ignore |
| Index value | | | | |
| UE Paging | M | | YES | ignore |
| ID | | | | |
| Paging | O | | YES | ignore |
| DRX | | | | |
| Paging | O | | YES | ignore |
| offset | | | | |
| CN Domain | M | | YES | ignore |
| List of | M | | YES | ignore |
| TAIs | | | | |
| >TAI List | | 1 to | EACH | ignore |
| Item | | <maxnoofTAI> | | |
| >>TAI | M | | — | |

When the eNB receives the paging message from the MME, the eNB determines the paging slot of the terminal by considering the contents of the paging offset field. Herein, the paging slot assignment rule for the second paging slot assignment scheme may be implemented using one of the following two equations.

UE_{—}ID=(IMSI+Paging offset)mod 1024 Equation 1

In Equation 1, UE_ID denotes an offset per terminal in the legacy LTE paging slot assignment rule. That is, when intervals are determined between paging groups and between PFs according to the system configuration, a paging group that a specific terminal will use is determined by using the UE_ID. Therefore, Equation 1 is used to choose a paging frame among determined paging frames. However, when the number of paging groups is ‘1,’ Equation 1 may not be used because there cannot be an offset if there is only ‘1’ group.

SFN mod T=(T div N)*(UE_{—}ID mod N)+Paging offset Equation 2

Here, SFN denotes a System Frame Number, T denotes a DRX cycle of a terminal, N denotes min (T, nB) wherein nB is one of 4T, 2T, T, T/2, T/4, T/8, T/16, and T/32, and UE_ID denotes an offset used for the terminal.

When Equation 2 is utilized, a PF itself of a specific terminal is changed at random, That is, another PF which is not one of PFs determined according to the system configuration but one for the specific terminal, may be configured. Therefore, Equation 2 can be applied when the number of paging groups is ‘1.’ However, because a PF may be generated for a new frame and not for a previous frame, a multiplexing effect of a paging message may be reduced.

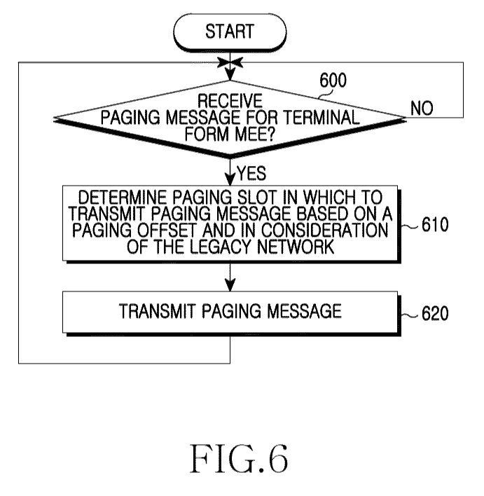

An eNB procedure for interworking an LTE network and a 1x network, according to an exemplary embodiment of the present invention, is described below with reference to FIG. 6.

FIG. 6 illustrates a BS operating procedure for interworking an LTE network and a 1x network according to an exemplary embodiment of the present invention.

Referring to FIG. 6, in step 600 the BS receives a paging message from an MME for a terminal. In step 610, the BS determines a paging slot in which to transmit the paging message based on a paging offset and in consideration of the legacy network. In step 620, the BS transmits the paging message in the determined paging slot. The BS operating procedure of FIG. 6 may be used with either the first or second paging slot assignment schemes. The BS may additionally perform any of the operations explicitly or implicitly described above as being performed by an eNB or a BS.

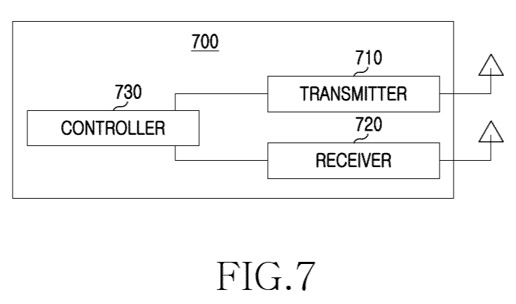

An exemplary structure of a terminal for use in an LTE network and a 1x network deployed in an overly mode is described below with reference to FIG. 7.

FIG. 7 illustrates a structure of a terminal for use in an LTE network and a 1x network deployed in an overly mode according to an exemplary embodiment of the present invention.

Referring to FIG. 7, the terminal 700 includes a transmitter 710, a receiver 720, and a controller 730. The terminal 700 may include any number of additional structural elements. However, a description of additional structural elements of the terminal 700 is omitted for conciseness.

The transmitter 710 transmits signals to the LTE network and the 1x network. The transmitter 710 may support the Radio Access Technology (RAT) of both the LTE network and the 1x network. The transmitter 710 may be able to switch between transmitting to the LTE network and the 1x network. Alternatively, the transmitter 710 may be able to simultaneously transmit to the LTE network and the 1x network. The transmitter 710 may comprise a plurality of transmitters.

The receiver 720 receives signals from the LTE network and the 1x network. The receiver 720 may support the RAT of both the LTE network and the 1x network. The receiver 720 may be able to switch between receiving from the LTE network and the 1x network. Alternatively, the receiver 720 may be able to simultaneously receive from the LTE network and the 1x network. The receiver 720 may comprise a plurality of receivers. The transmitter 710 and the receiver 720 may be a transceiver.

The controller 730 controls the transmitter 710 and the receiver 720 and controls the operations of the terminal 700. The operations of the terminal 700 include any of the operations explicitly or implicitly described above as being performed by a terminal. For example, the controller 730 may control to monitor a paging channel of the LTE network for a data paging message and a paging channel of the legacy network for a CS paging message, when the terminal 700 is in an idle state. In addition, the controller 730 may control to determine if one of the CS paging message and data paging message are received, and if one of the CS paging message and data paging message are received, control to establish a connection with the one of the LTE network and the legacy network corresponding to the received one of the CS paging message and data paging message.

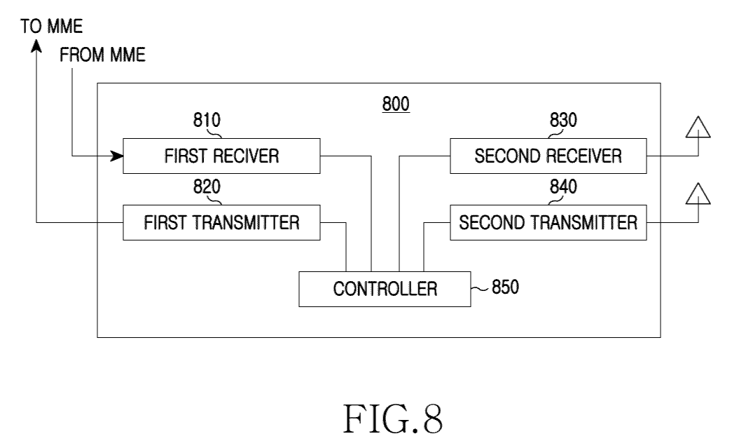

An exemplary structure of a BS for use with an LTE network, when the LTE network is deployed with a 1x network in an overly mode, is described below with reference to FIG. 8.

FIG. 8 illustrates an exemplary structure of a BS for use with an LTE network, when the LTE network is deployed with a 1x network in an overly mode, according to an exemplary embodiment of the present invention.

Referring to FIG. 8, the BS 800 includes a first receiver 810, a first transmitter 820, a second receiver 830, a second transmitter 840, and a controller 850. The BS 800 may include any number of additional structural elements. However, a description of additional structural elements of the terminal is omitted for conciseness of description. The BS 800 may be an eNB.

The first receiver 810 receives signals from an MME. The first transmitter 820 transmits signals to the MME. The first receiver 810 and the first transmitter 820 may be a transceiver.

The second receiver 830 receives signals from a terminal. The second receiver 830 may support the RAT of the LTE network. The second transmitter 840 transmits signals to the terminal. The second transmitter 840 may support the RAT of the LTE network. The second receiver 830 and the second transmitter 840 may be a transceiver.

The controller 850 controls the first receiver 810, the first transmitter 820, the second receiver 830, and the second transmitter 850, and controls the operations of the BS 800. The operations of the BS include any of operations explicitly or implicitly described above as being performed by an eNB or a BS. For example, the controller 840 may control to receive a paging message for a terminal from the MME via the first transmitter 810, control to determine a paging slot in which to transmit the paging message based on a paging offset and in consideration of the legacy network, and control to transmit the paging message in the determined paging slot via the second transmitter 840.

Accordingly, exemplary embodiments of the present invention are beneficial in that a quality of a voice service, which is a basic service of a wireless communication system, may be enhanced by improving the paging receiving probability for the 1x voice service without deteriorating LTE performance, when the LTE network and the 1x network are co-located in overlay mode and when the coverage of the LTE network is limited.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for operating a terminal in a wireless communication system including an advanced network that provides a data service and a legacy network that provides a Circuit Switched (CS) voice service, the method comprising:
monitoring a paging channel of the advanced network for a data paging message and a paging channel of the legacy network for a CS paging message, when the terminal is in an idle state after switching from an active state;
receiving one of the CS paging message and data paging message; and
establishing a connection with the one of the advanced network and the legacy network corresponding to the received one of the CS paging message and data paging message.

2. The method of claim 1, further comprising:
monitoring for a CS paging message when the terminal is connected to the advanced network; and
transitioning to an idle state from a state where the terminal is connected to the advanced network.

3. The method of claim 1, wherein the receiving of the one of the CS paging message and data paging message comprises receiving the CS paging message via the advanced network, when the terminal is connected to the advanced network.

4. The method of claim 1, further comprising performing location registration with the legacy network via the advanced network, when the terminal is connected to the advanced network.

5. The method of claim 1, further comprising performing location registration with the legacy network via the legacy network, when the terminal is in the idle state.

6. The method of claim 1, wherein the data paging channel of the advanced network and the CS paging channel of the legacy network do not overlap in time.

7. The method of claim 1, further comprising:
determining if the data paging channel of the advanced network and the CS paging channel of the legacy network overlap in time; and
transmitting a request for paging slot offset to the advanced network.

8. The method of claim 7, wherein the monitoring of the paging channel of the advanced network for the data paging message and the paging channel of the legacy network for the CS paging message comprises applying paging offset when monitoring the paging channel of the advanced network for the data paging message.

9. The method of claim 7, wherein the request for paging slot offset is included in one of an attachment request message for attaching to the advanced network and a Tracking Area Update (TAU) message for notifying the advanced network of a new tracking area.

10. The method of claim 9, wherein the request for paging slot offset is included in a Discontinuous Receive (DRX) parameter Information Element (IE) used for configuring the terminal's paging cycle in the advanced network.

11. The method of claim 1, wherein the legacy network comprises a 1x Radio Transmission Technology (RTT) network.

12. A method for operating a Base Station (BS) of an advanced network in a wireless communication system including the advanced network that provides a data service and a legacy network that provides a Circuit Switched (CS) voice service, the method comprising:
receiving from a Mobility Management Entity (MME) a paging message for a terminal;
determining a paging slot in which to transmit the paging message based on a paging offset and in consideration of the legacy network; and
transmitting the paging message in the determined paging slot.

13. The method of claim 12, wherein the paging offset is received from the MME.

14. The method of claim 12, further comprising:
receiving a paging slot offset request from the terminal; and
transmitting the received paging slot offset request to the MME.

15. The method of claim 14, wherein the paging offset request is received from the terminal in one of an attachment request message and a Tracking Area Update (TAU) message.

16. The method of claim 15, wherein the request for paging slot offset is included in a Discontinuous Receive (DRX) parameter Information Element (IE).

17. The method of claim 12, wherein the determining of the paging slot in which to transmit the paging message based on the paging offset and in consideration of the legacy network comprises:
determining an initial paging slot using substantially the same hash function and paging slot assignment procedure used in the legacy network; and
determining the paging slot in which to transmit the paging message by applying the paging offset to the initial paging slot.

18. The method of claim 12, wherein the determining of the paging slot in which to transmit the paging message based on the paging offset and in consideration of the legacy network comprises:
determining the paging slot in which to transmit the paging message using the equation,
UE_{—}ID=(IMSI+Paging offset)mod 1024,
where UE_ID denotes an offset used for the terminal and IMSI denotes an International Mobile Subscriber Identity of the terminal.

19. The method of claim 12, wherein the determining of the paging slot in which to transmit the paging message based on the paging offset and in consideration of the legacy network comprises:
determining the paging slot in which to transmit the paging message using the equation,
SFN mod T=(T div N)*(UE_{—}ID mod N)+Paging offset,
where SFN denotes a System Frame Number, T denotes a Discontinuous Reception (DRX) cycle of a terminal, N denotes min (T, nB) wherein nB is one of 4T, 2T, T, T/2, T/4, T/8, T/16, and T/32, and UE_ID denotes an offset used for the terminal.

20. The method of claim 12, further comprising:
determining if the terminal is an international roaming terminal; and
if the terminal is an international roaming terminal, the paging message is one of a paging message for the advanced network and a tunneled paging message for the legacy network.

21. The method of claim 20, wherein the terminal is determined to be an international roaming terminal based on an International Mobile Subscriber Identity (IMSI) of the terminal.

22. The method of claim 12, wherein the legacy network comprises a 1x Radio Transmission Technology ( ) network.

23. A terminal for use in a wireless communication system including an advanced network that provides a data service and a legacy network that provides a Circuit Switched (CS) voice service, the terminal comprising:
a transmitter for transmitting signals to the advanced network and the legacy network;
a receiver for receiving signals from the advanced network and the legacy network; and
a controller for controlling the transmitter and receiver, for controlling to monitor a paging channel of the advanced network for a data paging message and a paging channel of the legacy network for a CS paging message, when the terminal is in an idle state after switching from an active state, for controlling to determine if one of the CS paging message and data paging message are received, and if one of the CS paging message and data paging message are received, for controlling to establish a connection with the one of the advanced network and the legacy network corresponding to the received one of the CS paging message and data paging message.

24. The terminal of claim 23, wherein the controller controls to monitor for a CS paging message when the terminal is connected to the advanced network, and controls to transition to an idle state from a state where the terminal is connected to the advanced network.

25. The terminal of claim 23, wherein the received one of the CS paging message and data paging message comprises the CS paging message received via the advanced network, when the terminal is connected to the advanced network.

26. The terminal of claim 23, wherein the controller controls to perform a location registration with the legacy network via the advanced network, when the terminal is connected to the advanced network.

27. The terminal of claim 23, wherein the controller controls to perform a location registration with the legacy network via the legacy network, when the terminal is in the idle state.

28. The terminal of claim 23, wherein the data paging channel of the advanced network and the CS paging channel of the legacy network do not overlap in time.

29. The terminal of claim 23, wherein the controller controls to determine if the data paging channel of the advanced network and the CS paging channel of the legacy network overlap in time, and if the data paging channel of the advanced network and the CS paging channel of the legacy network overlap in time, controls to generate and transmit a request for paging slot offset to the advanced network.

30. The terminal of claim 29, wherein, the controller, when controlling to monitor the paging channel of the advanced network for the data paging message and the paging channel of the legacy network for the CS paging message, controls to apply a paging offset when controlling to monitor the paging channel of the advanced network for the data paging message.

31. The terminal of claim 29, wherein the request for paging slot offset is included in one of an attachment request message for attaching to the advanced network and a Tracking Area Update (TAU) message for notifying the advanced network of a new tracking area.

32. The terminal of claim 31, wherein the request for paging slot offset is included in a Discontinuous Receive (DRX) parameter Information Element (IE) used for configuring the terminal's paging cycle in the advanced network.

33. The terminal of claim 23, wherein the legacy network comprises a 1x Radio Transmission Technology (RTT) network.

34. A Base Station (BS) of an advanced network for use in a wireless communication system including an advanced network that provides a data service and a legacy network that provides a Circuit Switched (CS) voice service, the BS comprising:
a first receiver for receiving signals from a Mobility Management Entity (MME);
a first transmitter for transmitting signals to the MME;
a second receiver for receiving signals from the terminal;
a second transmitter for transmitting signals to the terminal; and
a controller for controlling the first receiver, first transmitter, second receiver and second transmitter, for controlling to receive a paging message for a terminal from the MME via the first transmitter, for controlling to determine a paging slot in which to transmit the paging message based on a paging offset and in consideration of the legacy network, and for controlling to transmit the paging message in the determined paging slot via the second transmitter.

35. The BS of claim 34, wherein the paging offset is received from the MME.

36. The BS of claim 34, wherein the controller controls to receive a paging slot offset request from the terminal via the second receiver, and controls to transmit the received paging slot offset request to the MME via the first transmitter.

37. The BS of claim 36, wherein the paging offset request is received from the terminal via the second receiver in one of an attachment request message and a Tracking Area Update (TAU) message.

38. The BS of claim 37, wherein the request for paging slot offset is included in a Discontinuous Receive (DRX) parameter Information Element (IE).

39. The BS of claim 34, wherein when the controller controls to determine the paging slot in which to transmit the paging message based on the paging offset and in consideration of the legacy network, the controller controls to determine an initial paging slot using substantially the same hash function and paging slot assignment procedure used in the legacy network, and controls to determine the paging slot in which to transmit the paging message by applying the paging offset to the initial paging slot.

40. The BS of claim 34, when the controller controls to determine the paging slot in which to transmit the paging message based on the paging offset and in consideration of the legacy network, the controller controls to determine the paging slot in which to transmit the paging message using the equation,
UE_{—}ID=(IMSI+Paging offset)mod 1024,
where UE_ID denotes an offset used for the terminal and IMSI denotes an International Mobile Subscriber Identity of the terminal.

41. The BS of claim 34, when the controller controls to determine the paging slot in which to transmit the paging message based on the paging offset and in consideration of the legacy network, the controller controls to determine the paging slot in which to transmit the paging message using the equation,
SFN mod T=(T div N)*(UE_{—}ID mod N)+Paging offset,
where SFN denotes a System Frame Number, T denotes a Discontinuous Reception (DRX) cycle of a terminal, N denotes min (T, nB) wherein nB is one of 4T, 2T, T, T/2, T/4, T/8, T/16, and T/32, and UE_ID denotes an offset used for the terminal.

42. The BS of claim 34, wherein the controller controls to determine if the terminal is an international roaming terminal, and
further wherein, if the terminal is an international roaming terminal, the paging message is one of a paging message for the advanced network and a tunneled paging message for the legacy network.

43. The BS of claim 41, wherein the controller controls to determine if the terminal is an international roaming terminal based on an International Mobile Subscriber Identity (IMSI) of the terminal.

44. The BS of claim 34, wherein the legacy network comprises a 1x Radio Transmission Technology (RTT) network.
